(19) United States
(12) Patent Application Publication
(10) Pub. No.: US 2011/0281129 A1
(43) Pub. Date: Nov. 17, 2011

(54) COMPOSITION COMPRISING A HYDROPHOBIN FOR GLUING PAPER PRODUCTS

(75) Inventors: Ulf Baus, Dossenheim (DE); Thorsten Montag, Dudenhofen (DE); Thomas Subkowski, Ladenburg (DE); Claus Bollschweiler, Heidelberg (DE); Franz-Josef Landen, Stuttgart (DE)

(73) Assignee: BASF SE, Ludwigshafen (DE)

(21) Appl. No.: 13/109,103

(22) Filed: May 17, 2011

Related U.S. Application Data
(63) Continuation-in-part of application No. PCT/EP2009/065467, filed on Nov. 19, 2009.

(30) Foreign Application Priority Data
Nov. 19, 2008 (EP) EP08169418.4

(51) Int. Cl. B32B 29/00; B42C 9/00; C09J 133/08; C09J 175/04; B05D 5/10; C09J 131/04

(52) U.S. Cl. 428/537.5; 427/207.1; 524/563; 524/562; 524/560; 524/590; 412/8

(57) ABSTRACT

The present invention relates to compositions comprising
a) 0.001-10% by weight of a hydrophobin (H),
b) an adhesive (A),
c) optionally a solvent and/or dispersant (S) and
d) optionally further additives (Z),
   and a corresponding method for the adhesive bonding of paper products, in particular for the adhesive bonding of printed products.

### RELATED APPLICATIONS

This application is a continuation-in-part of PCT/EP2009/065467, filed Nov. 19, 2009, which claims benefit of European application 08169418.4, filed Nov. 19, 2008. The entire contents of each of these applications is incorporated by reference herein.

### SEQUENCE LISTING

The Sequence Listing associated with this application is filed in electronic format via EFS-Web and hereby incorporated by reference into the specification in its entirety. The name of the text file containing the Sequence Listing is Sequence_List_{—}13156-00407_US. The size of the text file is 76 KB, and the text file was created on May 12, 2010.

### BACKGROUND OF THE INVENTION

The present invention relates to compositions comprising at least one hydrophobin (H) and an adhesive (A), and also to a corresponding method for the adhesive bonding of paper products, in particular for the adhesive binding of printed products.

Besides classical bookbinding methods using threads or wire stitching, various methods for adhesive binding have already been known for many years. Adhesive binding is understood as meaning binding methods for books and other printed products in which adhesives are applied to the spines of the cut book block, optionally with fanning-out, said adhesives ensuring that the sheets are held together.

Adhesive binding goes back to the technology, discovered by Emil Lumbeck around 1938, of fan adhesive binding (“Lumbecken”), which offers a cost-effective alternative to thread stitching. In this process, the book block consisting of individual sheets is fanned out at the end and the individual pages are each coated with an adhesive. The book block is then turned the right way up again and adhesively bonded on the back with gauze. Although this type of adhesive binding is stable, it is not suitable for mass production.

Industrially, adhesive binding takes place without fanning-out of the book block, meaning that the adhesive only adheres to the sheet edges. Nevertheless, in order to achieve a high strength of the adhesive binding, the book block spine is roughened prior to applying the adhesive in order to achieve a larger adhesive area and thus a higher strength of the binding. Despite continuous technical advances, ensuring the required strength values has hitherto not been satisfactorily solved.

Adhesive binding has been the preferred method for a long time for reasons of cost compared with other binding methods for paper products. It is inter alia the function of the adhesive to hold together the individual sheets via a sheet-edge adhesive binding or perhaps to attach a jacket to the book block. For the adhesive binding, hotmelt adhesives, reactive melt adhesives (e.g. polyurethane melt adhesives, so-called PUR adhesives) or adhesives based on water (for example dispersion adhesives) are usually used.

During hot gluing with hotmelt adhesives, a thermoplastic polymer (for example ethylvinyl acetate copolymers) is melted and then applied to the spine of the book. A disadvantage here is that a high energy input is required and the hot glue has a high viscosity. Moreover, the bindings obtained do not have adequate flexibility. This sometimes leads to a disadvantageous lay-flat behavior and to laid-open books closing again by themselves.

Aqueous adhesives (in the literature sometimes also referred to as cold glue or white glue) are also likewise used in print finishing and in particular in bookbinding. Aqueous adhesives based on natural polymers, such as, for example, glutine (glutine glue) or starch (or starch derivatives) and also adhesives based on synthetic polymers (such as polyvinyl alcohol) and dispersion adhesives, for example, are used. For book spine adhesive binding in bookbinding, predominantly dispersion adhesives are used.

The dispersion adhesives used consist predominantly of 40- to 60-% strength aqueous dispersions based on synthetic, film-forming polymers, preferably polyvinyl acetate and also other polyvinyl esters. They constitute an important group of adhesives in the field of print finishing and can be used for virtually all adhesive bonding work which arises. One advantage of the aqueous adhesives is that they have relatively low viscosities and as a result penetrate better into the pores of the paper. The resulting adhesive film is significantly thinner and more flexible compared to hot gluing.

### DESCRIPTION OF RELATED ART

The prior art also describes combinations (e.g. two-stage processes) using dispersion adhesives and hotmelt adhesives (see e.g. WO 1985/04669). Of importance for binding with dispersion adhesives is the accessibility of the paper fibers, which is improved in most cases by special spine processing, such as special cutting methods (see EP-A 1 063 104).

Standard commercial dispersion adhesives predominantly exhibit good flexibility after drying. However, adhesion of the sheets with the glue is often too low. Upon mechanical stress, for example as a result of repeated opening of the book, individual sheets become detached after a short time from the book unit.

The document DE-A 10 328 509 describes an aqueous adhesive for book manufacture to which, as component, gelatin or finely colloidal gelatin solution has been added. This is intended to ensure that the aqueous fraction of the dispersion penetrates more easily into the paper structure.

The document WO 2006/103225 describes the use of hydrophobin as adhesion promoter. However, this is directed to the adhesive bonding of plastic surfaces with one another and to the adhesive bonding of plastic surfaces with metal surfaces, with different prerequisites and requirements for the adhesive system.

### BRIEF SUMMARY OF THE INVENTION

An object of the present invention is to increase the adhesion of an aqueous adhesive with the fiber material. The resulting adhesive film should moreover have high flexibility. In addition, adhesive composition should have good processability in bookbinding. Within this, it should be mentioned for example that the adhesive composition has a low viscosity and sets quickly in order to ensure good processability and short processing times during manufacturing processes.

It has now been found that by adding special proteins, the hydrophobins, to adhesives for the adhesive bonding of paper products (for example during the adhesive binding of books), a surprisingly significant improvement in mechanical stability and flexibility of the resulting adhesive films can be achieved. Moreover, the adhesive composition according to the invention and the associated method according to the invention meets the requirements specified above such as high flexibility of the adhesive film, good processability and short processing times.

Hydrophobins are small, cysteine-rich proteins of about 100 to 150 amino acids, which occur e.g. in filamentous fungi such as Schizophyllum commune. They usually have 8 cysteine units in the molecule. Hydrophobins can be isolated from natural sources, although they can also be obtained by means of genetic engineering methods, as disclosed, for example in WO 2006/082 251 or WO 2006/131 564. The use of hydrophobins has already been proposed in the prior art for various applications. For example, WO 1996/41882 proposes the use of hydrophobins as emulsifiers, thickeners, surface-active substances, for the hydrophilization of hydrophobic surfaces, for improving the water resistance of hydrophilic substrates, for producing oil-in-water emulsions or water-in-oil emulsions.

Furthermore, pharmaceutical applications, such as the production of ointments, and also cosmetic applications and the production of hair shampoos are proposed. EP-A 1 252 516 discloses the coating of various substrates with a solution comprising hydrophobin at a temperature of 30 to 80° C. Furthermore, for example, the use of hydrophobins as demulsifier (see WO 2006/103251), as evaporation retarder (see WO 2006/128877) and soiling inhibitor (see WO 2006/103215) has already been proposed.

### BRIEF DESCRIPTION OF THE SEVERAL VIEWS OF THE DRAWING

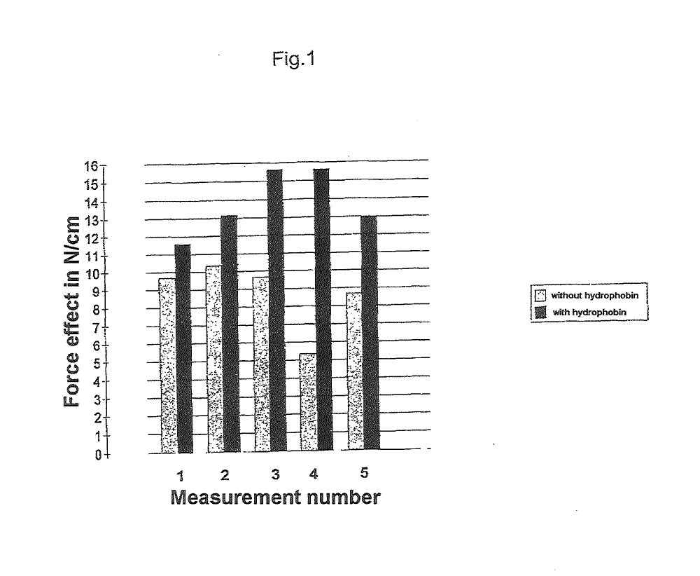

The forces (in N/cm) required to pull pages out of the various book blocks were determined by the so-called page-pull test, the results of which are shown in FIG. 1.

### DETAILED DESCRIPTION OF THE INVENTION

The present invention relates to a composition for the adhesive bonding of paper products, comprising (particularly consisting of):
a) 0.001-10% by weight of a hydrophobin (H),
b) an adhesive (A),
c) optionally a solvent and/or dispersant (S) and
d) optionally further additives (Z).

Preferably, the composition according to the invention for the adhesive bonding of paper products comprises (particularly consisting of):
a) 0.001-10% by weight of a hydrophobin (H),
b) 5-99.999% by weight of an adhesive (A),
c) 0-90% by weight of a solvent and/or dispersant (S),
d) 0-10% by weight of further additives (Z).

The composition according to the invention can have different consistencies depending on the application method and the adhesive used. It is possible for the composition to have a highly viscous paste-like consistency, i.e. a high adhesive fraction, or else to be a low viscosity liquid with a low adhesive fraction. Furthermore, the composition according to the invention also comprises the adhesive film on a paper product in all stages of the adhesive method (for example a ready-dried adhesive binding on the spine of the book and also the adhesive binding film on the spine of the book before drying).

In one preferred embodiment of the invention, the composition comprises:
a) 0.001-10% by weight of a hydrophobin (H),
b) 5-50% by weight of an adhesive (A),
c) 40-90% by weight of a solvent and/or dispersant (S),
d) 0-10% by weight of further additives (Z).

Two or more hydrophobins can be used together instead of a single hydrophobin (H). Two or more adhesives can be used together instead of a single adhesive (A).

Furthermore, preference is given to compositions comprising:
a) 0.001-10% by weight of a hydrophobin (H),
b) 50-99.999% by weight of an adhesive (A),
c) 0-40% by weight of a solvent and/or dispersant (S),
d) 0-10% by weight of further additives (Z).

In one preferred embodiment of the invention, the composition has a dynamic viscosity in the range from 500 to 2000 mPas, preferably a viscosity in the range from 500 to 1000 mPas.

Within the context of the present invention, the term “hydrophobins” is intended to mean hereinbelow polypeptides of the general structural formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C⁷—X₁₋₅₀—C⁸—Xₘ (I)

wherein each X independently denotes an amino acid sequence consisting of any of the 20 naturally occurring amino acids (Phe, Leu, Ser, Tyr, Cys, Trp, Pro, His, Gln, Arg, Ile, Met, Thr, Asn, Lys, Val, Ala, Asp, Glu, Gly). The numerical indices adjacent each X indicate the number of amino acid residues comprising each X, and each amino acid residue within each X independently may be identical or different to an adjacent residue(s). C is cysteine, alanine, serine, glycine, methionine or threonine, where at least four of the radicals designated C are cysteine, and the indices n and m, independently, are natural numbers between 0 and 500, preferably between 15 and 300, indicating the number of amino acid residues comprising the adjacent X.

The polypeptides according to formula (I) are also characterized by the property that, at room temperature, after coating a glass surface, they bring about an increase in the contact angle of a water drop of at least 20°, preferably at least 25° and particularly preferably 30°, in each case compared with the contact angle of an identically sized water drop with the uncoated glass surface.

The amino acids designated C¹ to C⁸ are preferably cysteines. However, they may also be replaced by other amino acids of similar spatial arrangement, preferably by alanine, serine, threonine, methionine or glycine. However, at least four, preferably at least 5, particularly preferably at least 6 and in particular at least 7, of the positions C¹ to C⁸ should consist of cysteines. Cysteines may be present in the proteins according to the invention either in reduced form, or form disulfide bridges with one another. Particular preference is given to the intramolecular formation of C—C bridges, in particular those with at least one, preferably 2, particularly preferably 3 and very particularly preferably 4, intramolecular disulfide bridges. In the case of the above-described replacement of cysteines by amino acids of similar spatial arrangement, such C positions are advantageously exchanged in pairs which can form intramolecular disulfide bridges with one another.

If cysteines, serines, alanines, glycines, methionines or threonines are also used in the positions referred to as X, numbering of the individual C positions in the general formulae can change accordingly.

Preference is given to using hydrophobins of the general formula (II)

Xₙ—C¹—X₃₋₂₅—C²—X₀₋₂—C³—X₅₋₅₀—C⁴—X₂₋₃₅—C⁵—X₂₋₁₅—C⁶—X₀₋₂—C⁷—X₃₋₃₅—C⁸—Xₘ (II)

for carrying out the present invention, where X, C and the indices alongside X and C have the above meaning, the indices n and m are numbers between 0 and 350, preferably 15 to 300, the proteins are further characterized by the aforementioned contact angle change, and furthermore at least 6 of the radicals designated C are cysteine. It is particularly preferred that all of the radicals C are cysteine.

Particular preference is given to using hydrophobins of the general formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices alongside X have the above meaning, the indices n and m are numbers between 0 and 200, the proteins are further characterized by the aforementioned contact angle change, and at least 6 of the radicals designated C are cysteine. It is particularly preferred that all of the radicals C are cysteine.

The radicals Xₙ and Xₘ may be peptide sequences which are naturally also linked to a hydrophobin. However, it is also possible for one or both radicals to be peptide sequences which are naturally not linked to a hydrophobin. These are also understood as meaning those radicals Xₙ and/or Xₘ in which a peptide sequence which occurs naturally in a hydrophobin is extended by a peptide sequence which does not occur naturally in a hydrophobin.

If Xₙ and/or Xₘ are peptide sequences which are naturally not linked to hydrophobins, such sequences are generally at least 20, preferably at least 35, amino acids in length. They may be for example sequences made of 20 to 500, preferably 30 to 400 and particularly preferably 35 to 100 amino acids. Such a radical which is naturally not linked to a hydrophobin will also be referred to below as a fusion partner. This expression is intended to mean that the proteins can consist of at least one hydrophobin part and a fusion partner part which do not occur together in this form in nature. Fusion hydrophobins made of fusion partner and hydrophobin part are described for example in WO 2006/082251, WO 2006/082253 and WO 2006/131564.

The fusion partner part can be selected from a large number of proteins. It is possible for just a single fusion partner to be linked to the hydrophobin part, or it is also possible for a plurality of fusion partners to be linked to a hydrophobin part, for example on the amino terminus (Xₙ) and on the carboxy terminus (Xₘ) of the hydrophobin part. However, it is also possible, for example, for two fusion partners to be linked to one position (Xₙ or Xₘ) of the protein according to the invention.

Particularly suitable fusion partners are proteins which occur naturally in microorganisms, in particular in Escherischia coli or Bacillus subtilis. Examples of such fusion partners are the sequences yaad (SEQ ID NO: 16 in WO 2006/082251 and herein), yaae (SEQ ID NO: 18 in WO 2006/082251 and herein), ubiquitin and thioredoxin. Also highly suitable are fragments or derivatives of these specified sequences which comprise only part, for example 70 to 99%, preferably 5 to 50%, and particularly preferably 10 to 40%, of the specified sequences, or in which individual amino acids, or nucleotides have been altered compared with the specified sequence, the percentages given in each case referring to the number of amino acids.

The assignment of the sequence names to DNA and polypeptide sequence and the corresponding sequence protocols can be found in the application WO 2006/103225 (p. 13 of the description and sequence protocol) and paragraph [0071] of US Publication 2009/0233110, both of which are incorporated herein by reference in their entireties.

In a further preferred embodiment, besides the specified fusion partner, the fusion hydrophobin has, as one of the groups Xₙ or Xₘ or as terminal constituent of such a group, also a so-called affinity domain (affinity tag/affinity tail). In a manner known in principle, these are anchor groups which are able to interact with certain complementary groups and can serve for easier work-up and purification of the proteins. Examples of such affinity domains comprise (His)ₖ-, (Arg)ₖ-, (Asp)ₖ-, (Phe)ₖ- or (Cys)ₖ- groups, where k is in general a natural number from 1 to 10. Preferably, it may be a (His)ₖ group, where k is 4 to 6.

Here, the group Xₙ and/or Xₘ can consist exclusively of such an affinity domain or else a radical Xₙ or Xₘ linked naturally or non-naturally to a hydrophobin is extended by a terminally arranged affinity domain.

The hydrophobins used according to the invention can also be modified in their polypeptide sequence, for example by glycosylation, acetylation or else by chemical crosslinking, for example with glutardialdehyde.

One property of the hydrophobins used according to the invention, or derivatives thereof, is the change in surface properties if the surfaces are coated with the proteins. The change in surface properties can be determined experimentally for example by measuring the contact angle of a drop of water before and after coating the surface with the protein and calculating the difference between the two measurements.

The procedure of measuring the contact angles is known in principle to the person skilled in the art. The measurements refer to room temperature and to water drops of 5 μl and the use of glass plates as substrate. The precise experimental conditions for a method, suitable by way of example, for measuring the contact angle are laid down in the experimental section. Under the conditions specified therein, the fusion proteins used according to the invention have the property of increasing the contact angle by at least 20°, preferably at least 25°, particularly preferably at least 30°, in each case compared with the contact angle of an identically sized water drop with the uncoated glass surface.

Particularly preferred hydrophobins for carrying out the present invention are the hydrophobins of the type dewA, rodA, hypA, hypB, sc3, basf1, basf2. These hydrophobins including their sequences are disclosed for example in WO 2006/082251 and U.S. Pat. No. 7,892,788, which are incorporated herein by reference in its entireties. Unless stated otherwise, the sequences given below refer to the sequences disclosed in WO 2006/082251 and U.S. Pat. No. 7,892,788. An overview table with the SEQ ID numbers is given in WO 2006/082251 on page 20 and in U.S. Pat. No. 7,892,788, col. 14, lines 1-25.

According to the invention, the fusion proteins yaad-Xa-dewA-his (SEQ ID NO: 20), yaad-Xa-rodA-his (SEQ ID NO: 22) or yaad-Xa-basf1-his (SEQ ID NO: 24) with the polypeptide sequences given in brackets, and also the nucleic acid sequences coding for these, in particular the sequences according to SEQ ID NOs: 19, 21 and 23 are particularly suitable. Particular preference is given to using the hydrophobin yaad-Xa-dewA-his (SEQ ID NO: 20).

Proteins which are produced starting from the polypeptide sequences depicted in SEQ ID NOs: 20, 22 or 24 as a result of exchange, insertion or deletion of at least one, up to 10, preferably 5, particularly preferably 5%, of all amino acids and which still have at least 50% of the biological property of the starting proteins are also particularly preferred embodiments. Biological property of the proteins is understood here as meaning the change in the contact angle by at least 20° as already described.

Derivatives of particular suitability for carrying out the present invention are derivatives derived from yaad-Xa-dewA-his (SEQ ID NO: 20), yaad-Xa-rodA-his (SEQ ID NO: 22) or yaad-Xa-basf1-his (SEQ ID NO: 24) by shortening the yaad fusion partner. Instead of the complete yaad fusion partner (SEQ ID NO: 16) with 294 amino acids, a shortened yaad radical may advantageously be used. The shortened radical should, however, comprise at least 20, preferably at least 35, amino acids. For example, a shortened radical having 20 to 293, preferably 25 to 250, particularly preferably 35 to 150 and for example 35 to 100 amino acids, can be used. One example of such a protein is yaad40-Xa-dewA-his (SEQ ID NO: 26 in PCT/EP2006/064720 and herein), which has a yaad radical shortened to 40 amino acids. A cleavage site between the hydrophobin and the fusion partner or fusion partners can be used to cleave off the fusion partner and to release the pure hydrophobin in underivatized form (for example by BrCN cleavage on methionine, factor Xa, enterokinase, thrombin, TEV cleavage etc.).

The hydrophobins present in the composition according to the invention for the adhesive bonding of paper products can be produced chemically by known methods of peptide synthesis, such as, for example, by solid-phase synthesis in accordance with Merrifield. Naturally occurring hydrophobins can be isolated from natural sources by means of suitable methods. By way of example, reference may be made to Wosten et al., Eur. J. Cell. Bio. 63, 122-129 (1994) or WO 1996/41882. A genetic engineering production method for hydrophobins without fusion partner from Talaromyces thermophilus is described by US 2006/0040349.

The preparation of fusion proteins can preferably take place by genetic engineering methods in which one nucleic acid sequence, in particular DNA sequence, coding for the fusion partner and one nucleic acid sequence, in particular DNA sequence, coding for the hydrophobin part are combined such that the desired protein is produced in a host organism as a result of gene expression of the combined nucleic acid sequence. Such a production method is disclosed for example by WO 2006/082251 or WO 2006/082253. The fusion partners make the production of the hydrophobins considerably easier. Fusion hydrophobins are produced in the genetic engineering methods with considerably better yields than hydrophobins without fusion partners.

The fusion hydrophobins produced by the genetic engineering method from the host organisms can be worked up in a manner known in principle and be purified by means of known chromatographic methods. In one preferred embodiment, the simplified work-up and purification method disclosed in WO 2006/082253, pages 11/12 can be used. For this, the fermented cells are firstly separated off from the fermentation broth and disrupted, and the cell debris is separated off from the inclusion bodies. The latter can advantageously take place by centrifugation. Finally, the inclusion bodies can be disrupted in a manner known in principle for example by acids, bases and/or detergents in order to release the fusion hydrophobins. The inclusion bodies with the fusion hydrophobins used according to the invention can generally be completely dissolved within ca. 1 h using just 0.1 m NaOH.

The solutions obtained can—optionally after establishing the desired pH—be used without further purification for carrying out this invention. The fusion hydrophobins can however also be isolated from the solutions as solid. Preferably, the isolation can take place by means of spray granulation or spray drying, as described in WO 2006/082253, page 12. The products obtained by the simplified work-up and purification method comprise, besides remains of cell debris, generally ca. 80 to 90% by weight of proteins. The amount of fusion hydrophobins is generally 30 to 80% by weight, with regard to the amount of all proteins, depending on the fusion construct and fermentation conditions.

The isolated products comprising fusion hydrophobins can be stored as solids and be dissolved for use in the media desired in each case.

The fusion hydrophobins can be used as such or else, following cleavage and separation of the fusion partner, as “pure” hydrophobins for carrying out this invention. A cleavage is advantageously carried out after the isolation of the inclusion bodies and their dissolution.

In one preferred embodiment of the invention, the hydrophobin (H) used is at least one fusion hydrophobin with a polypeptide sequence selected from the group of SEQ ID NO: 20, SEQ ID NO: 22 and SEQ ID NO: 24.

The composition according to the invention described above comprises hydrophobin in a range from 0.001 to 10% by weight (based on the total composition), preferably in the range from 0.005 to 10% by weight, particularly preferably in the range from 0.01 to 5% by weight, very particularly preferably in the range from 0.01 to 1% by weight.

In one preferred embodiment, the composition for the adhesive bonding of paper products comprises at least one hydrophobin (component H) in the range from 0.001 to 0.1% by weight.

The component A present in the composition according to the invention can very generally be understood as meaning an adhesive (cf. DIN EN 923), i.e. a nonmetallic substance which can join together joining parts by surface adherence (adhesion) and internal strength (cohesion). Adhesives may be physically setting adhesives (for example hotmelt adhesives, dispersion adhesives or glues) or chemically setting adhesives (reactive adhesives), such as for example polyurethane adhesives.

In one preferred embodiment of the invention, the composition for the adhesive bonding of paper products comprises at least one adhesive (A) which is usually used in paper finishing and print finishing. Those adhesives usually used in print finishing are listed below, although the list is not exhaustive:
Adhesives based on natural or semi-natural polymers,
   starch adhesives, comprising potato starch, corn starch, wheat starch, manioca starch, tapioca starch and rice starch in native or degraded form, in various degrees of degradation, in cold- or warm-soluble form, with variously adjusted degrees of gelatinization,
   dextrin adhesives, produced by thermal or chemical degradation of potato starch, corn starch, wheat starch, manioca starch, tapioca starch and rice starch;
   glutine glues,
   starch/dextrin mixed glues,
   cellulose adhesives, cellulose derivative adhesives.
Adhesives based on synthetic polymers, such as for example
   hotmelt adhesives based for example on vinyl acetate (hotmelt adhesives),
   reactive polyurethane hotmelt adhesives (PUR reactive adhesives),
   polyvinyl alcohol adhesives,
   or dispersion adhesives comprising homo- or copolymers of vinyl acetate, ethylvinyl acetate, acrylates, styrene acrylate, and also dispersion adhesives comprising polyurethane.

Within the context of the invention, dispersion adhesives are to be understood here as meaning a dispersion of an organic basic substance (for example a polymer or copolymer of vinyl ester or acrylates) in liquid dispersants in which the organic basic substance is insoluble. The dispersions may optionally also comprise plasticizers, resins or fillers. Aqueous-based dispersion adhesives comprise water as the main constituent of the dispersant.

In one preferred embodiment of the invention, the adhesive component (A) in the composition consists of a dispersion adhesive, in particular one based on water. Particular preference is given to dispersion adhesives comprising homopolymers or copolymers of vinyl acetate, ethylvinyl acetate, acrylates, styrene acrylate or a polyurethane.

Very particularly preferably, the adhesive component A comprises at least one of the following dispersion adhesives:
EMULDUR® (BASF, Ludwigshafen, Germany), (anionic polyester/polyurethane in aqueous dispersion),
ADHESIN®A7362 (Henkel, Dusseldorf, Germany), (polyvinyl acetate),
ACRONAL®A508 (BASF, Ludwigshafen, Germany), (acrylic ester copolymer dispersion).

The composition according to the invention can optionally comprise 0-90% by weight of one (or also more) solvent and/or dispersant (S), preference being given to using water. However, it is also possible to use other polar, water-miscible solvents and/or dispersants such as alcohols (e.g. methanol, ethanol, n-propanol, n-butanol, isopropanol, cyclohexanol); carboxylic acids (e.g. formic acid, acetic acid); carboxylic acid esters (e.g. ethyl acetate), ketones (e.g. acetone). It is also possible to use, as component (S), mixtures of different solvents and/or dispersants. It is also conceivable for the solvent and/or dispersant (S) to also comprise nonpolar solvents. The definition of the solvent and/or dispersant (S) includes for example dispersants of a dispersion adhesive and solvents of the hydrophobin component.

The composition according to the invention can optionally comprise further additives (Z), e.g. those which are customarily present in adhesive compositions for print finishing. Examples to be mentioned here are:
a) plasticizers,
b) fillers,
c) preservatives,
d) photostabilizers,
e) antifoams,
f) rheology improvers, for example
   LUPHEN®D200A from BASF, Ludwigshafen, DE
   EMULDUR®DS2360 from BASF, Ludwigshafen, DE
   IMPRANIL®DLP-R from Bayer-Leverkusen, DE
g) thickeners, for example
   BORCHIGEL®0435 from Borchers, Langenfeld, DE.

In a particular embodiment of the invention the inventive composition comprises at least one wetting agent in a range from 0.0001 to 10% by weight, particularly in a range from 0.0001 to 1% by weight, preferably in arrange from 0.0001 to 0.1% by weight (in each case based on the total composition) as “further additive (Z)”.

In terms of the present invention a wetting agent is a surfactant, i.e. a surface-active agent, which reduces the surface tension of a liquid in which the surfactant is dissolved or the interfacial tension to a second liquid phase. In particular a wetting agent (also referred to as wetter in the following) supports the wetting of a surface with a liquid in which the wetting agent is dissolved.

The wetting agent can particularly be selected from the group consisting of: ethoxylated alcohols, ethoxylated acids (such as ethoxylated carboxylic acids, ethoxylated fatty acids), siloxanes, modified (e.g. polyether modified) siloxanes, particulary trisiloxanes, ionic siloxanes, particularly also anionic surfactants and fine-particle silica.

In particular addition products of 0 to 30 mol ethylene oxide, particularly 10 to 25, particularly 12 to 20 mol ethylene oxide and/or 0 to 5 mol propylene oxide to linear fatty alcohols with 8 to 22 carbon atoms (e.g. stearyl alcohol, cetyl alcohol) can be used as ethoxylated alcohols. Preferably alkyl (poly) ethylene glycols can be selected from the group consisting of (poly) ethylene glycol (12 to 20) stearyl ether, (poly) ethylene glycol (12 to 20) isostearyl ether, (poly) ethylene glycol (12 to 20) cetyl ether, (poly) ethylene glycol (12 to 20) isocetyl ether, (poly) ethylene glycol (12 to 20) oleyl ether, (poly) ethylene glycol (12 to 20) lauryl ether, (poly) ethylene glycol (12 to 20) isolauryl ether, (poly) ethylene glycol (12 to 20) cetyl stearylether.

Furthermore, it is possible to use addition products of 0 to 30 mol ethylene oxide and/or 0 to 5 mol propylene oxide to linear alkyl phenols with 8 to 15 carbon atoms in the alkyl group as surfactant (wetting agent), in particular octyl phenol (poly)ethylen glycol ether (TRITON®).

In a further embodiment fatty acid ethoxylates (acyl (poly) ethylene glycoles) can be used as wetting agent, particularly addition products of 0 to 30 mol ethylene oxide, particularly 10 to 25, particularly 12 to 20 mol ethylene oxide and/or 0 to 5 mol propylene oxide to linear fatty acids with 8 to 22 carbon atoms (e.g. stearic acid, isostearic acid, oleic acid). In particular one (or more) fatty acid ethoxylate can be used selected from the group consisting of (poly) ethylene glycol (12 to 25) stearate, (poly) ethylene glycol (12 to 20) isostearate, (poly) ethylene glycol (12 to 25) oleate.

Furthermore, it is possible to use glycerole mono- or di-esters of saturated and unsaturated fatty acids with 6 to 22 carbon atoms and optionally their addition products with ethylene oxide of 0 to 30 mol ethylene oxide, particularly 10 to 25, particularly 12 to 25. Particularly, here a surfactant can be used selected from the group consisting of: (poly) ethylene glycol (20) glyceryl laurate, (poly) ethylene glycol (6) glyceryl caproate/caprate, (poly) ethylene glycol (20) glyceryl oleate, (poly) ethylene glycol (20) glyceryl isostearate, and (poly) ethylene glycol (18) glyceryl oleate/cocoate.

Sorbitan mono- or di-esters of saturated and unsaturated fatty acids with 6 to 22 carbon atoms and optionally their addition products with ethylene oxide of 0 to 30 mol ethylene oxide, particularly 10 to 25 mol, particularly 12 to 25 mol are likewise suitable. Preferably ethoxylated sorbitan fatty acid esters can be used as surfactant (wetting agent) selected from the group of (poly) ethylenglycol(20) sorbitanmonolaurate (TWEEN®20), (poly) ethylenglycol(20) sorbitanmonostearate, (poly) ethylenglycol(20) sorbitanmonoisostearate, (poly) ethylenglycol(20) sorbitanmonopalmitate and (poly) ethylenglycol(20) sorbitan monooleate

Likewise, ethoxylated fatty amines, fatty acid amides, alkanoleamine soap, fatty acid amide (poly) ethylene glycols, polypropylene glykolethoxylates (Poloxamere, PLURONICS®), fatty acid N-methylglycamides, saccharose ester, (poly) glycol ether, alkyl polyglycosides, phosphoric acid esters (mono-, di-, and tri phosphoric acid esters ethoxylated and not ethoxylated) can be used as surfactant (wetting agent).

Ionogenic surfactants can also be used as wetting agent, preferably anionic surfactants, such as mono-, di- or trimesters of phosphoric acid, sodium stearate, sodium laurylsulfate, sodium laurylsarcosinate, sodium dioctylsulfosuccinate, sodium diisooctylsulfosuccinate (e.g. EMULSOGEN®SF8), sodium alkyl naphtaline sulfonate, fatty alcohol sulfate, alkyl ether sulfate (e.g. disodium lauryl diglycolethersulfate), ethoxylated alkylether carboxylic acid or their salts (e.g. sodium laurethyl (11EO) carboxylate). Furthermore, cationic surfactens such as mono-, di- and tri-alkyl quats and their polymeric derivatives can also be used.

In a further embodiment siloxanes and/or modified siloxane are used as surfactant (wetting agent). Particularly, siloxanes can be oligomeric or polymeric siloxanes and/or modified siloxanes. For example oligomeric and/or polymeric siloxanes can be used which are modified with alkyl-, vinyl-, or amino-groups. Furthermore, the use of polyether modified siloxanes, as e.g. of a polyether modified trimethoxysilane (DYNSYLAN®4144) is preferred. In particular, the use of polyether modified tri-siloxanes is preferred. Preferred polyether modified siloxanes can be obtained by reaction of linear or cyclic mono-, oligo- and/or polysiloxanes which are optionally modified with ethylene oxide and/or propylene oxide. In particular polyether modified siloxane addition products of 0 to 30 mol ethylene oxide, particularly 10 to 25 mol, particularly 12 to 20 mol and/or 0 to 5 mol propylene oxide of linear and/or cyclic mono-, oligo- and/or polysiloxanes can be used, preferably trisiloxane.

Furthermore, siloxanes can be used selected from the group of heptamethyl trisiloxane, lauryl trisiloxane and stearyl trisiloxane. Furthermore, amino-, alkyl-, and/or vinyl modified siloxanes and/or oligo siloxanes can be used (e.g. surfactants of trademark DYNSYLLAN® and DYNSYLLAN®Hydrosil)

In a preferred embodiment of the invention the described composition comprises as a further additive (Z) at least one surfactant (wetting agent) in the range from 0.0001 to 10% by weight, particularly in the range of 0.0001 to 1% by weight, preferably in the range of 0.0001 to 0.1% by weight selected from the group consisting of polyether modified trisiloxanes (e.g. BREAKTRU®, DYNASYL®4144), alkyl modifies siloxanes, amino modified siloxanes, amino-/alkyl-modified siloxanes (e.g. DYNASYL®Hydrosil2627), heptamethyl trisiloxane (SILWET® L-77), (poly) oxyethylen(20) sorbitan monolaurate (Polysorbat 20, TWEEN®20), octylphenol (poly) ethylenglycol(9 to 10) ether (TRITON®), (poly) ethylenglycol(12 to 20) stearyl ether, (poly) ethylenglycol(12 to 20) laurylether and (poly) ethylenglycol(12 to 20) cetylether.

In a preferred embodiment mixtures of two or more of the above described wetting agents were used in the composition. In one particularly preferred embodiment of the invention, the composition for the adhesive bonding of paper products comprises the following components (or preferably is composed of these):
a) 0.001-1% by weight of a hydrophobin (H),
b) 5-99.999% by weight of a dispersion adhesive (A),
c) 0-90% by weight of a solvent and/or dispersant (S), comprising water,
d) 0-10% by weight of further additives (Z).

Very particular preference is given to compositions comprising the following components (or preferably is composed of these):
a) 0.001-1% by weight of at least one fusion hydrophobin (H) with a polypeptide sequence selected from the group SEQ ID NO: 20, SEQ ID NO: 22 and SEQ ID NO: 24,
b) 5-99.999% by weight of an adhesive (A) selected from the group of acrylate dispersion adhesives, acrylate-styrene dispersion adhesives or aqueous polyurethane adhesives,
c) 0-95% by weight of water (S)
d) 0-10% by weight of further additives (Z).

It is also possible for the composition to consist of at least two parts which are produced, delivered and applied separately to the paper product. The parts comprise at least one adhesive (component A) and a hydrophobin (component H). Preferably, the parts comprise an aqueous dispersion adhesive (A) and an aqueous solution of at least one hydrophobin.

Within the context of the present invention, paper products are to be understood in particular as meaning graphic arts papers, packaging papers, hygiene papers and special papers. Within the context of the invention, graphic arts papers are to be regarded as all papers for printing, writing and copying, e.g. photo printing and digital printing. Packaging papers are to be understood as meaning papers, cardboards and card for packaging purposes. Within the context of the invention, hygiene papers are papers with high volume and high absorbency which are typically used in the sanitary sector or kitchen sector. The expression special papers refers to papers and cards for special technical intended uses.

Preferably, the invention relates to graphic arts papers. Particularly preferably, the invention relates to graphic arts papers which have already been subjected to a printing process, in particular to photo printing and digital printing. However, it is also possible to use unprinted papers within the context of the invention.

Within the context of the invention, paper products also include products which have been produced by joining paper products specified above, thus for example products or intermediates of bookbinding, such as books, brochures, catalogues, writing blocks, book blocks, jackets.

The present invention also comprises a method for the adhesive bonding of a paper product, where the components of the composition described above are applied to the paper product.

In a preferred embodiment of the method, firstly a composition comprising at least one hydrophobin (H) and then a composition comprising the adhesive (A) is applied to the paper product (two-stage method).

In a further preferred embodiment, the components of the composition described above are mixed and applied to a paper product. Preference is given to using compositions comprising at least one hydrophobin (H), an adhesive (A), optionally a solvent and/or dispersant (S) and optionally further additives with the weight fractions described above (single-stage process).

In one preferred single-stage embodiment, an aqueous solution of at least one hydrophobin (H) is mixed with an aqueous dispersion adhesive (A) and optionally further additives (Z) and applied to the paper product. It is possible to use (optionally purified) hydrophobin solutions, as are produced in one of the described production methods for hydrophobin. The composition obtained in this way is applied to the printed product in a suitable customary application device.

In the two-stage embodiment of the method, firstly the solution of the hydrophobin (H) in the solvent and/or dispersant (preferably water) and then in a second step the adhesive optionally comprising a solvent and/or dispersant (S) and further additives (Z) are applied to the paper product to be adhesively bonded.

In particular, hydrophobin solutions with a hydrophobin content in the range from 0.001-10% by weight, preferably in the range from 0.005-10% by weight, particularly preferably in the range from 0.01 to 5% by weight and very particularly preferably in the range from 0.01-1% by weight, are used. In a further embodiment of the invention, dilute hydrophobin solutions with a hydrophobin content of from 0.001 to 0.1% by weight are applied.

Solvents which can be used are the aforementioned solvents and/or dispersants, preferably water.

In one particular embodiment of the invention, firstly an aqueous solution comprising 0.001 to 10% by weight, preferably 0.005 to 10% by weight, particularly preferably 0.01 to 5% by weight, very particularly preferably in the range from 0.01 to 1% by weight, of at least one hydrophobin (H) and then a composition comprising the adhesive (A) are applied to the paper product. In a further preferred embodiment, an aqueous solution comprising 0.001 to 0.1% by weight of at least one hydrophobin (component H) is applied to the paper product.

Optionally, after applying the hydrophobin solution and before applying an adhesive component, the paper product can be dried (“two-shot method”).

Preferably, the application takes place without interim drying, i.e. “wet-in-wet”. Here, a hydrophobin-comprising solution is applied to the paper product and, immediately afterwards, an adhesive component is applied to the wet fibers, for example via a nozzle.

In a particularly preferred embodiment of the invention, firstly an aqueous solution comprising 0.001 to 10% by weight of at least one hydrophobin (H) and then immediately afterwards, without interim drying (“wet-in-wet”), an aqueous dispersion adhesive (A) are applied to the paper product, where the hydrophobin is a fusion hydrophobin with a polypeptide sequence selected from the group SEQ ID NO: 20, SEQ ID NO: 22 and SEQ ID NO: 24, and where the paper product is a book block spine.

In particular, further a two-stage method as described above is preferred in which the above described hydrophobin solution comprises as a further additive (Z) at least one wetting agent in the range from 0.0001 to 10% by weight, preferably in the range from 0.001 to 10% by weight, further preferred in the range from 0.005-10% by weight, particularly preferred in the range of 0.01 to 5% by weight, more preferred in the range of 0.01-1% by weight. In an embodiment the hydrophobin solution comprises at least one wetting agent as further additive (Z) in the range from 0.0001 to 0.1% by weight. The given ranges in % by weight are based on the whole weight of aqueous hydrophobin solution.

Here, the above-mentioned wetting agents can be used in particular. Preferably, at least one surfactant (wetting agent) used as further additive (Z) is selected from the group consisting of polyether modified trisiloxanes (e.g. BREAKTRU®, DYNASYL®4144), alkyl modifies siloxanes, amino modified siloxanes, amino-/alkyl-modified siloxanes (e.g. DYNASYL®Hydrosil2627), heptamethyl trisiloxane (SILWET® L-77), (poly) oxyethylen (20) sorbitan-monolaurate (Polysorbat 20, TWEEN®20), octylphenol (poly) ethylenglycol(9 to 10) ether (TRITON®), (poly) ethylenglycol (12 to 20) stearyl ether, (poly) ethylenglycol (12 to 20) laurylether and (poly) ethylenglycol (12 to 20) cetylether.

In a preferred embodiment mixtures of two or more, particularly 2 to 5, of the above-mentioned wetting agents are used.

In an embodiment of the invention a hydrophobin solution as described above can be used in a two-stage method as described in the present application, wherein the hydrophobin solution exhibits a surface tension in the range of 10 to 50 mN/m, particularly in the range of 20 to 40 mN/m, often also in the range of 30 to 35 mN/m. The surface tension of the hydrophobin solution can be of importance for specific application areas and can also be adjusted specifically via type and amount of the additional used wetting agent.

In this embodiment too, dried hydrophobins or (optionally purified) hydrophobin solutions can be used, as are produced during one of the described production methods for hydrophobin.

The application can take place in particular with the help of a known manual or machine method, such as for example nozzle or roller application.

Here, the application of the composition according to the invention preferably takes place in a binding machine for dispersion adhesives (so-called cold glues) with a nozzle application system. Preferably, prior to the application process, a step for book block spine processing takes place in which the fibers of the page edges are exposed.

The invention comprises moreover the use of at least one hydrophobin in a method for the adhesive bonding of a paper product.

The invention comprises moreover the use of at least one hydrophobin as auxiliary in compositions for the adhesive bonding of paper products during print finishing.

A preferred embodiment of the invention comprises the use of at least one hydrophobin as described above, where the hydrophobin is used as auxiliary in aqueous adhesives during print finishing. The use during book binding and in particular the adhesive binding of book blocks is particularly preferred.

Preferably, at least one hydrophobin is used according to the invention as auxiliary in aqueous dispersion adhesives during print finishing, preferably during the adhesive binding of printed products, in particular of printed products of digital printing or photo printing.

Very particular preference is given to the use of a fusion protein with a polypeptide sequence selected from the group of SEQ ID NO: 20, SEQ ID NO 22 and SEQ ID NO 24 as auxiliary in aqueous dispersions during the adhesive binding of paper products.

The composition according to the invention is preferably used as adhesive system in all steps of print finishing. The term print finishing comprises all processing steps by means of which the intended products with their particular shapes and properties are produced from the printed (or also unprinted) pre-products. In particular, methods and steps of bookbinding which include adhesive bonding are to be understood within the context of the invention. Here, the following applications may be specified by way of example:

adhesive binding of books, brochures, catalogues, writing blocks; ungluing, block gluing, encasing of book blocks, sticking on of jackets, book cover production, end-paper adhesive bonding, spine ungluing, page gluing, back-gluing, sticking in of cards and samples, laminating, gumming, self-adhesive gumming, pressure-sensitive gumming, label manufacture.

The invention further relates to paper products, such as, for example, books, brochures, writing blocks, which have been adhesively bonded using an above-described composition according to the invention.

The invention relates in particular to products of bookbinding, such as books, brochures, catalogues, calendars, writing blocks or similar printed articles which have been bonded using an above-described composition according to the invention.

The following examples are intended to illustrate the invention in more detail:

### Example 1

### Preparation of the Hydrophobins

For the examples, a fusion hydrophobin with the complete fusion partner yaad (yaad-Xa-dewA-his (SEQ ID NO: 20; referred to hereinbelow as hydrophobin A) and also a fusion hydrophobin with a fusion partner shortened to 40 amino acids yaad40-Xa-dewA-his (SEQ ID NO: 26; hydrophobin B) were used. The hydrophobins were prepared in accordance with the procedure described in WO 2006/082253. The products were worked up by the simplified purification method as in example 9 of WO 2006/82253 and spray-dried as in example 10. The total protein content of the resulting dried products was in each case ca. 70 to 95% by weight, the content of hydrophobins was ca. 40 to 90% by weight, with regard to the total protein content. The products were used as such for the experiments.

### Example 2

### Applications-Related Testing of the Hydrophobins

Characterization of the fusion hydrophobins by contact angle change of a water drop on glass (window glass, Süddeutsche Glas, Mannheim):

For the tests, the spray-dried fusion-hydrophobin comprising products were dissolved in water with the addition of 50 mM Na acetate pH 4 and 0.1% by weight of polyoxyethylene(20) sorbitan monolaurate (TWEEN® 20). The concentration of the product was 100 μg/ml in aqueous solution.

### Procedure:

incubation of glass plates overnight (temperature 80° C.), then coating washing in distilled water,
then incubation for 10 min/80° C./1% sodium dodecyl sulfate (SDS) solution in dist. water,
washing in dist. water

The samples are dried in the air and the contact angle (in degrees) of a drop of 5 μl of water is determined at room temperature. The contact angle measurement was determined on a Dataphysics Contact Angle System OCA 15+, Software SCA 20.2.0 instrument (November 2002). Measurement was carried out in accordance with the manufacturer's instructions.

Untreated glass produced a contact angle of 15° to 30°±5°. A coating with the fusion hydrophobin yaad-Xa-dewA-his₆ produced a contact angle increase of more than 30°; a coating with the fusion hydrophobin yaad40-Xa-dewA-his likewise produced a contact angle increase of more than 30°.

### Example 3

### Production of the Adhesive Bonds and Determination of the Mechanical Stability of the Adhesive Bonds

A book block (DIN A4, i.e. spine length of 297 mm) was clamped in book block tongs such that the edge to be bound protruded about 2 mm free from the tongs (so-called overhang). This book block is roughened using a milling device. As a result of this pretreatment, the fibers are exposed. The roughened book block spine is then wetted (“slightly moist”) with a 0.1% strength by weight aqueous solution of a spray-dried fusion hydrophobin A (yaad-Xa-dewA-his), which has been prepared as described in example 1. Then, in a bookbinding machine of the type Ribler Junior Binder or Ribler Express Binder (manufacturer Ribbler, Stuttgart), an adhesive dispersion with the following composition is applied wet in wet via a nozzle.
75% by weight of styrene-acrylate type 525, manufacturer Scott Bader, UK 25% by weight of styrene-acrylic acid ester, DA 194, manufacturer Ercros, DE

The adhesive dispersion had a viscosity (measured using Ford cup, 5 mm nozzle) of <1000 mPas.

### Example 4

### Determination of the Mechanical Stability of the Adhesive Bindings

Book blocks each 2 cm in thickness and made of different sorts of paper (No. 1 to No. 5) were adhesively bonded as described in example 3. As comparative examples, book blocks without hydrophobin pretreatment and likewise of 2 cm thickness were roughened analogously to the above-described method and adhesively bonded in a binding machine of the type Ribler Junior Binder or Ribler Express Binder (manufacturer Ribbler, Stuttgart, DE) using the above-described adhesive formulation via a nozzle.

The forces (in N/cm) required to pull pages out of the various book blocks were determined by the so-called page-pull test. Here, the adhesive binding to be tested was clamped into the pull test device in the opened state. Then, a single page is removed from the adhesive binding using a clamping rail with gradually increasing tensile force or until the paper tears. The greater the required tensile force given in N/cm, the stronger the adhesive binding.

The results of the page-pull test are shown in FIG. 1. It can be seen that the strength values with hydrophobin are 20-100% higher than the comparative examples without hydrophobin.

### Example 5

### Assessment of Cohesive Failure (COH) and Adhesive Failure (AHD)

To assess adhesion and cohesion, the adhesive binding was opened flat and viewed under a microscope. The edge of a page was pulled, stretching the seam of adhesive. If the adhesive detaches from the paper fiber, then this is adhesive failure. If, on the other hand, the adhesive does not tear at the paper fiber, but in the middle of the seam of adhesive, then this is cohesive failure.

In the case of book blocks which have been adhesively bonded in a conventional manner, it is easy to see under a microscope how the adhesive detaches relatively easily from the fiber. If the book block spine has been treated beforehand with hydrophobin as described in example 3, a cohesive failure can be seen under a microscope, i.e. the adhesive film splits in the middle and adhesive residues are left hanging on the fibers.

### Example 6

### Generation of Advantageous Surface Tension Via Addition of a Further Additive (Z)

0.04 ml of a surfactant based on alcohol alkoxylates (Tego Surten W11, manufacture e.g. Degussa/Evonik, Deutschland) was added to 100 ml of a 0.1% strength by weight aqueous solution of a spray-dried fusion hydrophobin A, which has been prepared as described in example 1. The determined surface tension was 33 mN/m. So, excellent wetting properties were achieved with this solution. This improves the adhesive binding during bonding of paper products.

We claim:

1. A composition for the adhesive bonding of paper products comprising
a) 0.001-10% by weight of a hydrophobin (H),
b) an adhesive (A),
c) optionally, at least one of a solvent or dispersant (S), and
d) optionally, a further additive (Z).

2. The composition of claim 1 comprising:
a) 0.001-10% by weight of a hydrophobin (H),
b) 50-99.999% by weight of an adhesive (A),
c) 0-40% by weight of at least one of a solvent or dispersant (S),
d) 0-10% by weight of further additives (Z).

3. The composition of claim 1, wherein the hydrophobin (H) comprises from 0.001-0.1% by weight of the composition.

4. The composition of claim 1, wherein the adhesive (A) is selected from the group of dispersion adhesives consisting of homopolymers and copolymers of vinyl acetate, ethylvinyl acetates, acrylates, styrene acrylates and polyurethanes.

5. The composition of claim 1, wherein the hydrophobin (H) is a fusion hydrophobin comprising a polypeptide sequence selected from the group consisting of SEQ ID NO: 20, SEQ ID NO: 22 and SEQ ID NO: 24.

6. The composition of claim 1, wherein the further additive (Z) comprises a wetting agent from 0.0001 to 10% by weight of the composition.

7. A method for the adhesive bonding of a paper product, wherein a composition comprising
a) 0.001-10% by weight of a hydrophobin (H),
b) an adhesive (A),
c) optionally, at least one of a solvent or dispersant (S), and
d) optionally, a further additive (Z)
is applied to the paper product.

8. The method of claim 7, wherein a composition comprising the hydrophobin (H) first is applied to the paper product, then a composition comprising the adhesive (A) is applied to the paper product.

9. The method of claim 7, wherein an aqueous solution comprising 0.001-10% by weight of the hydrophobin (H) is first applied to the paper product, then a composition comprising the adhesive (A) is applied to the paper product.

10. The method of claim 7, wherein an aqueous solution comprising 0.001-10% by weight of the hydrophobin (H) is applied to the paper product, then immediately afterward and without interim drying, an aqueous dispersion of the adhesive (A) is applied to the paper product, wherein the hydrophobin (H) is a fusion hydrophobin comprising a polypeptide sequence selected from the group consisting of SEQ ID NO: 20, SEQ ID NO: 22 and SEQ ID NO: 24, and wherein the paper product is a book block spine.

11. The method of claim 7, wherein the further additive (Z) comprises a wetting agent comprising from 0.0001 to 10% by weight of the composition.

12. The method of claim 7, wherein the hydrophobin (H), the adhesive (A), the at least one of a solvent or dispersant (S) and the further additive (Z) are mixed and applied to a paper product.

13. The method of claim 7, wherein an aqueous solution of the hydrophobin (H) is mixed with an aqueous dispersion of the adhesive (A) and, optionally, the further additive (Z), and applied to the paper product.

14. A paper product that has been adhesively bonded with a composition comprising
a) 0.001-10% by weight of a hydrophobin (H),
b) an adhesive (A),
c) optionally, at least one of a solvent or dispersant (S), and
d) optionally, a further additive (Z).


SEQUENCE LISTING (37 sequences)

SEQ ID NO: 1 - DNA, 405 bp, Aspergillus nidulans
  CDS (1)..(405): basf-dewA hydrophobin
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
  basf-dewA hydrophobin
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471): basf-rodA hydrophobin
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
  basf-rodA hydrophobin
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Artificial Sequence
  CDS (1)..(336): basf-hypA from chemically synthesized polynucleotide
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Artificial Sequence
  basf-hypA from chemically synthesized polynucleotide
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Artificial Sequence
  CDS (1)..(357): basf-hypB from chemically synthesized polynucleotide
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Artificial Sequence
  basf-hypB from chemically synthesized polynucleotide
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schyzophyllum commune
  CDS (1)..(408): basf-sc3 hydrophobin, cDNA template
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schyzophyllum commune
  basf-sc3 hydrophobin, cDNA template
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  CDS (1)..(483): basf-BASF1 from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  basf-BASF1 from chemically synthesized polynucleotide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  CDS (1)..(465): basf-BASF2 from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  basf-BASF2 from chemically synthesized polynucleotide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882): basf-yaad yaad
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
  basf-yaad yaad
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591): basf-yaae yaae with Gly insert at position 2
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
  basf-yaae yaae with Gly insert at position 2
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  CDS (1)..(1329): basf-yaad-Xa-dewA-his fusion of Bacillus subtilis yaad and N-terminal factor Xa proteinase cleavage site and Aspergillus nidulans hydrophobin dewA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  basf-yaad-Xa-dewA-his fusion of Bacillus subtilis yaad and N-terminal factor Xa proteinase cleavage site and Aspergillus nidulans hydrophobin dewA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  CDS (1)..(1395): basf-yaad-Xa-rodA-his fusion of Bacillus subtilis yaad and N-terminal factor Xa proteinase cleavage site and Aspergillus nidulans hydrophobin rodA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  basf-yaad-Xa-rodA-his fusion of Bacillus subtilis yaad and N-terminal factor Xa proteinase cleavage site and Aspergillus nidulans hydrophobin rodA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  CDS (1)..(1407): basf-yaad-Xa-BASF1-his fusion of Bacillus subtilis yaad and N-terminal factor Xa proteinase cleavage site and artificial hydrophobin; BASF1  BASF1 from chemically synthesized polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  basf-yaad-Xa-BASF1-his fusion of Bacillus subtilis yaad and N-terminal factor Xa proteinase cleavage site and artificial hydrophobin BASF1; BASF1 from chemically synthesized polynucleotide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 561 bp, Artificial sequence
  CDS (1)..(561): DNA sequence encoding fusion protein yaad40-Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 26 - protein, 187 aa, artificial sequence
  fusion protein yaad40-Xa-dewA-his
MAQTGTERVKRGMAEMQKGGVIMDVINAEQAKIAEEAGAVIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 27 - DNA, 28 bp, Artificial Sequence
  Chemically synthesized Hal570 primer
gcgcgcccatggctcaaacaggtactga

SEQ ID NO: 28 - DNA, 28 bp, Artificial Sequence
  Chemically synthesized Hal571 primer
gcagatctccagccgcgttcttgcatac

SEQ ID NO: 29 - DNA, 30 bp, Artificial Sequence
  Chemically synthesized Hal572 primer
ggccatgggattaacaataggtgtactagg

SEQ ID NO: 30 - DNA, 33 bp, Artificial Sequence
  Chemically synthesized Hal573 primer
gcagatcttacaagtgccttttgcttatattcc

SEQ ID NO: 31 - DNA, 38 bp, Artificial Sequence
  Chemically synthesized KaM416 primer
gcagcccatcagggatccctcagccttggtaccagcgc

SEQ ID NO: 32 - DNA, 50 bp, Artificial Sequence
  Chemically synthesized KaM417 primer
cccgtagctagtggatccattgaaggccgcatgaagttctccgtctccgc

SEQ ID NO: 33 - DNA, 45 bp, Artificial Sequence
  Chemically synthesized KaM434 primer
gctaagcggatccattgaaggccgcatgaagttctccattgctgc

SEQ ID NO: 34 - DNA, 30 bp, Artificial Sequence
  Chemically synthesized KaM435 primer
ccaatggggatccgaggatggagccaaggg

SEQ ID NO: 35 - DNA, 38 bp, Artificial Sequence
  Chemically synthesized KaM418 primer
ctgccattcaggggatcccatatggaggagggagacag

SEQ ID NO: 36 - DNA, 32 bp, Artificial Sequence
  Chemically synthesized KaM464 primer
cgttaaggatccgaggatgttgatgggggtgc

SEQ ID NO: 37 - DNA, 35 bp, Artificial Sequence
  Chemically synthesized KaM465 primer
gctaacagatctatgttcgcccgtctccccgtcgt